(19) United States
(12) Patent Application Publication
(10) Pub. No.: US 2026/0170842 A1
(43) Pub. Date: Jun. 18, 2026

(54) LOAD SLIPPAGE DETECTION SYSTEM FOR A VEHICLE AND VEHICLE

(71) Applicant: Motherson Innovations Company Limited, London (GB)

(72) Inventor: Romeo Wieczorek, Esslingen (DE)

(73) Assignee: Motherson Innovations Company Limited, London (GB)

(21) Appl. No.: 19/417,671

(22) Filed: Dec. 12, 2025

(30) Foreign Application Priority Data
Dec. 16, 2024 (DE) 102024138114.0

(51) Int. Cl. G06V 20/56; B60R 11/04; B60W 40/13; B60W 50/14

(52) U.S. Cl. CPC G06V 20/56; B60R 11/04; B60W 40/13; B60W 50/14

(57) ABSTRACT

A load slippage detection system for a vehicle includes at least one image data capturing device attachable to the exterior of the vehicle. The at least one image data capturing device can capture an image data for the exterior of the vehicle, and an electronic control unit (ECU) can process the captured image data to generate a primary plane (P1) in a static position without load and a secondary plane (P2) in a driving position when loaded. The ECU can further determine a primary height (H1) of the primary plane (P1) and secondary height (H2a, H2b, H2c, H2d) of the secondary plane (P2) from the ground and compare the primary height (H1) of the primary plane (P1) with the secondary height (H2a, H2b, H2c, H2d) of the secondary plane (P2) for detecting load slippage.

### CROSS-REFERENCE TO RELATED APPLICATIONS

This application claims priority from German Patent Application No. DE102024138114.0, filed Dec. 16, 2024. The disclosure of which is incorporated herein by reference in its entirety.

### BACKGROUND OF THE INVENTION

This invention relates in general to trailer load monitoring. In particular, this invention relates to load slippage detection system for a vehicle according to the preamble of claim 1. Further, the present disclosure relates to a vehicle with such a load slippage detection system.

While a vehicle is in operational/driving mode, it is important to know the driving dynamic state of the load that is present in the vehicle. It has been observed that many vehicles carrying loads often face problems in transportation of the goods. There are several situations when the disbalance of the load towards the either left or right direction inside the cabin of the vehicle due to bumpy and uneven roads causes the vehicle to slip, thereby leading to an accident and causing injuries to the driver and co-passengers.

Thus, securing load is a very important topic in logistics, but often far too little attention is paid to it due to time pressure when placing and securing the load on the vehicle or negligence or ignorance of the dangers and unpredictable situations that can arise. If a load shifts in a vehicle it can be due to a variety of reasons. Even if the load is strapped down properly, the straps could loosen and the load can shift unintentionally and/or unrecognized. This shifting and/or displacement can cause the truck to lean or even tilt. The leaning position can lead to uncontrollability of the truck in driving situations and is therefore extremely dangerous. Especially as the leaning position may only affect the trailer and may not be apparent in the passenger compartment.

DE 10 2021 201 522 A1 describes a method for determining a spatial orientation of a trailer of an autonomously driving towing vehicle combination. In this method, sensor data from a number of different sensor types are processed so that the trailer and surrounding objects are identified in the sensor data, with the sensor data transmitted by the different sensor types and processed in this way being combined with one another and using this combined sensor data to determine the trajectory of the trailer in relation to be determined by the surrounding objects.

WO 2004/109 326 A1 relates to a device for determining the spatial orientation of a semi-trailer or trailer connected to a towing vehicle, with sensor means arranged on the towing vehicle for generating sensor signals which describe the spatial orientation of the semi-trailer or trailer relative to the towing vehicle, the sensor means detecting contours of the semi-trailer or trailer. The sensor signals generated by the sensor means contain image information of a two-dimensional representation and/or a linear scan of the detected contours of the semi-trailer or trailer. On the basis of the image information, an evaluation unit determines at least one angle value which describes an angle between the tractor vehicle and the semi-trailer or trailer. In addition, if information about the spatial orientation of the tractor vehicle is available, in particular information about the pitching and/or rolling motion of the tractor vehicle, the pitching and/or rolling motion of the semi-trailer or trailer relative to the road surface can be determined.

There are developments in how to evaluate sensor signals to determine at least one angle which describes an angle between a vehicle and a trailer. Basically, the sensor signals include image information of a linear sub-area of the detected contours of the trailer. Then, a horizontal bend-angle of the trailer relative to the vehicle (the angle between two straight lines being parallel to the street) is detected on the basis of the image information by evaluating the rate of change of geometric characteristics represented in the recorded image. Thus, the angle of the trailer relative to the vehicle in regard to the bend angle is detected but the load slippage is ignored, which can cause the vehicle to tip or slip.

Therefore, there is a need to develop a cost-effective and safe system and method for detecting a load slippage of a vehicle.

Hence, the invention overcomes at least partly the known drawbacks of the prior art. In particular, the invention provides a cost-effective system for detecting a load slippage of a vehicle. Furthermore, the invention provides a load slippage detection system which can detect and provide an alert to the driver about the driving dynamics information of the vehicle relatively easily and safely.

The invention is achieved by the features of claim 1 and the various embodiments of the load slippage detection system for a vehicle as described in claims 2 to 17. The invention is further achieved by a vehicle incorporating the load slippage detection system of any of claims 1 to 17.

### SUMMARY OF THE INVENTION

This invention relates to a load slippage detection system. The system may comprise at least one image data capturing device configured to attach at the exterior of the vehicle and to capture image data for exterior of the vehicle. An electronic control unit (ECU) is configured to process the captured image data to generate a primary plane in a static position without load and a secondary plane in a driving position when loaded. The ECU is further configured to determine a primary height of the primary plane and secondary height of the secondary plane from the ground and compare the primary height of the primary plane with the secondary height of the secondary plane for detecting load slippage.

According to the present disclosure, the load slippage detection system may comprise at least one image data capturing device, where the at least one image data image capturing device is configured to be attached at the exterior of any one of A-pillars, and/or doors of the vehicle. Particularly, the load slippage detection may comprise two image data capturing devices.

The at least one image data capturing device may be configured to attach at a left side of the vehicle capturing the position of left side of a mounting frame of the vehicle and at least one image data capturing device may be configured to attach at a right side of the vehicle capturing the position of right side of the mounting frame of the vehicle.

The primary height of the primary plane may be prestored in the ECU. Further, the primary plane may be a rectangular plane having the same primary height of all the four edges of the mounting frame from the ground and the secondary plane may be a rectangular plane having secondary height of the four edges from the ground.

The ECU may further be configured to detect a load slippage on an event when any one of the secondary heights do not match with primary height. The ECU may further be configured to send alert notification in the form of an audio announcement and/or a haptic feedback to the driver.

The comparison between any one of the secondary heights with the primary height may be based on data collected by the ECU for at least 3 minutes, in particular at least 5 minutes, more particularly at least 10 minutes, even more particularly at least 15 minutes, following the commencement of driving of the vehicle. The time may change based on the level of difference of the compared heights.

In another aspect, at least one image data capturing device may further capture a location of reflector lights at each rear end of the vehicle and may transfer the captured location of the reflector lights to the ECU. The ECU may be configured to determine the height of the captured location of the reflector lights from the ground and may compare the determined heights of reflector lights for detecting load slippage of the vehicle in an event when the height of the reflector light may not equal to height of the reflector light.

The at least one image data capturing device may be configured to attach on the left side of the vehicle to capture the location of reflector light and at least one image data capturing device may be configured to attach on the right side of the vehicle to capture the location of reflector light.

The ECU may be configured to send an alert notification to the vehicle's driver when load slippage is detected by comparison of the heights of the primary plane and secondary plane, and by comparison of heights of the reflector lights. The alert notification may be in the form of audio and/or haptic feedback to the driver.

The invention is also related to a vehicle with a load slippage detection system as described above.

The consequence of a load shift or slippage can be an inclined position of the truck. For the driver and other road users, this means a danger and would lead in some countries to a fine if detected by the police. To avoid such dangerous situations, the content of this disclosure is the detection of inclined positions that may arise due to load shifts/slippages, different tire pressures or other causes. Thus, the claimed subject matter is based on the astonishing perception that it is possible to determine both dynamic and static conditions of a vehicle and load by using a camera-monitor system (CMS). Therefore, the invention can include portions or elements from currently available systems. For example, camera monitor systems are used in order to replace rear view mirrors. Using such systems already used with vehicles saves costs and time during production and reduces the parts needed in a vehicle.

It should be noted that the features set out individually in the following description can be combined with each other in any technically advantageous manner and set out other forms of the present disclosure. It should be understood, however, that the disclosure is not limited to the precise arrangements and instrumentalities shown. The accompanying drawings, which are incorporated in and constitute a part of this specification, illustrate an implementation of system, apparatuses, and methods consistent with the present description and, together with the description, serve to explain advantages and principles consistent with the disclosure. The figures are not necessarily drawn to scale. Like numbers used in the figures refer to like components. However, it will be understood that the use of a number to refer to a component in a given figure is not intended to limit the component in another figure labelled with the same number. The description further characterizes and specifies the present disclosure in particular in connection with the Figures.

Various aspects of this invention will become apparent to those skilled in the art from the following detailed description of the preferred embodiment, when read in light of the accompanying drawings.

### BRIEF DESCRIPTION OF THE DRAWINGS

FIG. 1A illustrates a vehicle in accordance with an embodiment of the present disclosure.

FIG. 1B illustrates an exemplary schematic of primary plane according to an embodiment of the present disclosure.

FIG. 2A illustrates a vehicle with a load in accordance with an embodiment of the present disclosure.

FIG. 2B illustrates an exemplary schematic of secondary plane according to an embodiment of the present disclosure.

FIG. 3 illustrates a back view of a vehicle in accordance with an embodiment of the present disclosure.

### DETAILED DESCRIPTION OF THE PREFERRED EMBODIMENT

The foregoing objects, features and advantages of the present disclosure will become more apparent from the following detailed description related to the accompanying drawings. However, various modifications may be applied to the present disclosure, and the present disclosure may have various embodiments of the present disclosure. Hereinafter, specific embodiments of the present disclosure, which are illustrated in the drawings, will be described in detail.

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

In the drawings, the thicknesses of layers and regions may be exaggerated for clarity. When it is indicated that an element or layer is “on” or “above” another element or layer, this comprises a case in which another layer or element is interposed therebetween as well as a case in which the element or layer is directly above the other element or layer. In principle, reference signs designate elements throughout the specification. In the following description, the same reference signs are used to designate elements, which have the same function within the same idea illustrated in the drawings of each embodiment of the present disclosure.

When detailed description of known functions or configurations related to the present disclosure is deemed to unnecessarily blur the gist of the disclosure, the detailed description thereof will be omitted. Also, numerals (e.g., first, second, etc.) used in the description herein are merely identifiers for distinguishing one element from another element.

In addition, the terms “module” and “unit” used to refer to elements in the following description are given or used in combination only in consideration of ease of writing the specification, and the terms themselves do not have distinct meanings or roles.

Furthermore, the use of a singular term, such as, “a” is not to be interpreted as limiting the number of components or details of particular components. Additionally, various terms and/or phrases describing or indicating a position or directional reference such as, but not limited to, “top”, “bottom”, “front”, “rear”, “forward”, “rearward”, “end”, “outer”, “inner”, “left”, “right”, “vertical”, “horizontal”, etc. may relate to one or more particular components as seen generally from a user's vantage point during use or operation, and such terms and/or phrases are not to be interpreted as limiting, but merely as a representative basis for describing the disclosure to one skilled in the art. In addition, a suffix “region”, “part”, “unit” for a component used in the following description are given or mixed in consideration of only the ease of writing the specification, and do not have meanings or roles distinguished from each other.

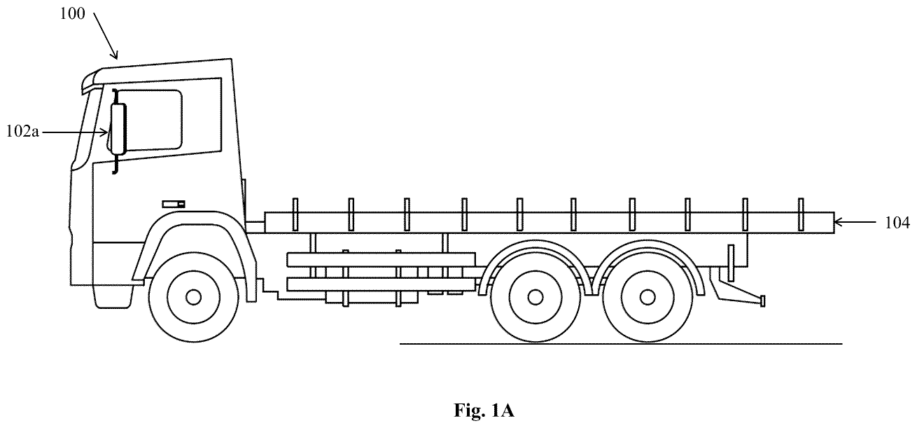

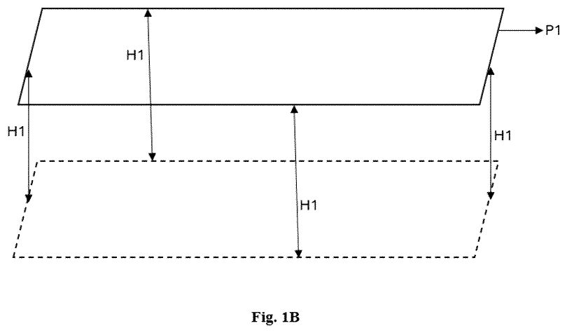

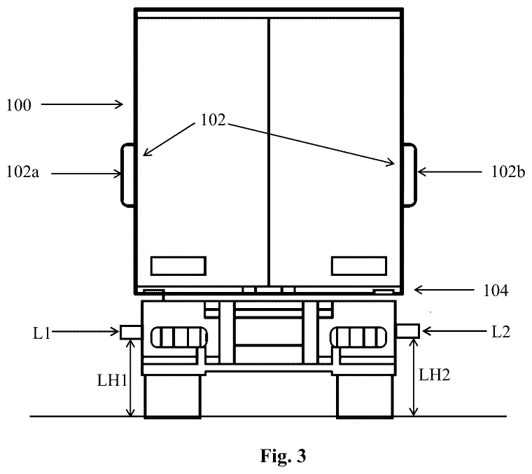

FIG. 1A shows a vehicle 100 in accordance with aspects of the present disclosure. As shown in the figure, a vehicle 100 comprising a load slippage detection system is disclosed. The load slippage detection system comprises at least one image data capturing device 102 that is configured to be attached at the exterior of the vehicle 100. Particularly, there may be two image data capturing devices, e.g. one image data capturing device 102a on one side of the vehicle 100 and a further image data capturing device 102b (not shown) being disposed at an opposite side of the exterior of the vehicle 100. This is e.g. shown in FIG. 3. The load detection system further comprises an ECU (not shown) comprising an image data processor that processes image data captured by the at least one image data capturing device 102. The image data or signal communication from the image data capturing device 102a, 102b to the ECU may comprise any suitable data or communication link, such as vehicle network bus or the like of the equipped vehicle 100. The ECU is embedded in the interior of the vehicle 100.

The two image data capturing devices 102a, 102b capture position of horizontally placed mounting frame 104 on left side and right side of the vehicle 100 and the captured positioning of the mounting frame 104 is transferred to the ECU. The ECU is further configured to generate a primary plane P1 and a primary height H1 is determined from the primary plane P1 to the surface of the ground as shown in FIG. 1B. The primary height H1 is determined in a static position of the vehicle 100 before or during loading or after unloading and the primary height H1 is prestored in the ECU. The primary plane P1 may be defined and optionally constrained by the exterior edges of the vehicle 100, optionally by the edges of a horizontal cross-section through the vehicle 100, which may be the mounting frame 104. In various embodiments only one first primary height H1 may be captured being somewhere in the defined primary plane P1. In various further embodiments a plurality of primary heights H1 may be captured being positioned on the restricting edges of the primary plane P1 or in the corners of the primary plane P1.

In an embodiment, the primary plane P1 is a rectangular plane and have same primary height H1 of all the four edges of the mounting frame 104 from the ground.

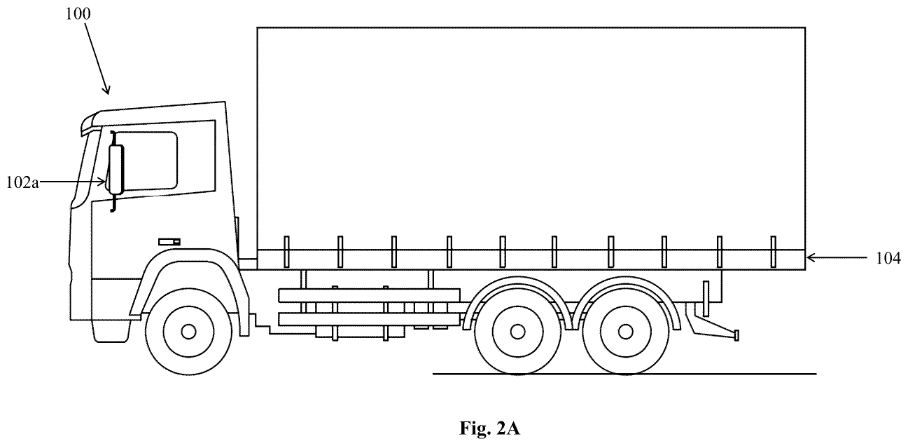

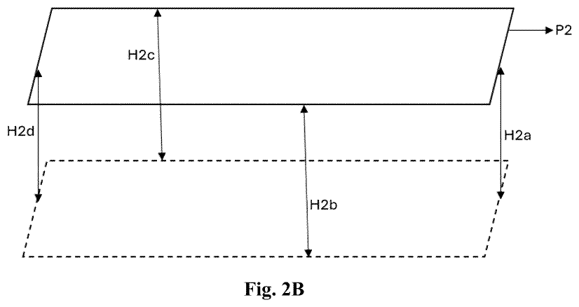

FIG. 2A shows a vehicle 100 comprising a load slippage detection system according to an embodiment of the present disclosure. The load slippage detection system comprises at least one image data capturing device 102 that is configured to attach at the exterior of the vehicle 100. Particularly, there are two image data capturing devices 102a, 102b, of which one image data capturing device 102a is shown in FIG. 2A, being disposed at each end of the exterior of the vehicle 100. The load detection system further comprises an ECU (not shown) comprising image data processor that processes image data captured by the at least one image data capturing device 102a. The image data or signal communication from the image data capturing device 102a to the ECU may comprise any suitable data or communication link, such as vehicle network bus or the like of the equipped vehicle 100. The ECU may be embedded in the interior of the vehicle 100.

The two image data capturing devices 102a, 102b (see e.g. FIG. 3) captures position of horizontally placed mounting frame 104 on right side and left side of the vehicle 100 when loaded with goods. The captured positions are transferred to the ECU, wherein the ECU is configured to generate a secondary plane P2, and further ECU determines a height from the secondary plane P2 to the surface of the ground.

In an embodiment, the secondary plane P2 is a rectangular plane having secondary heights H2a, H2b, H2c, H2d of the four edges from the ground as shown in FIG. 2B. In an embodiment, the secondary plane P2 and the primary plane P1 belong to the same horizontal cross section of the vehicle 100 or are parallel to each other or cross each other. The location of the secondary heights H2a, H2b, H2c, H2d may be in the corners of the four edges or somewhere between the corners. In further embodiments one or two heights are defined and captured along an edge of the secondary plane.

Once the goods are loaded in the vehicle 100 static mode, the ECU is configured to compare the secondary heights H2a, H2b, H2c, H2d. In order to commence driving of the vehicle 100, all the four secondary heights H2a, H2b, H2c, H2d should be equal. If the secondary heights are not equal, the ECU may not allow the commencement of the vehicle 100 and alert the driver about the uneven load. The reason of secondary heights not being equal after loading may be due to uneven load of goods during manual loading.

In an embodiment, once the ECU confirms that the secondary height H2a, H2b, H2c, H2d are equal after manual loading of the goods, the ECU alerts the driver of the vehicle 100 to shift from static mode to driving mode. In the driving mode, the secondary height H2a, H2b, H2c, H2d of the secondary plane P2 related to the mounting frame 104 of the vehicle 100 is again generated by the ECU wherein the ECU compares the secondary height H2a, H2b, H2c, H2d with the height H1 of the mounting frame 104 in the static state without any load. The ECU is configured to send an alert message to the vehicle's driver when a load slippage is detected when any one of secondary heights H2a, H2b, H2c, H2d of the secondary plane P2 does not match with the height H1 of the primary plane P1.

An alert message can be generated and transmitted to the driver of the vehicle 100 in case of such detection of the load slippage. The alert message may be in the form of audio alarm or a notification by way of SMS, MMS, and the like.

The ECU is configured to compare the secondary height H2a, H2b, H2c, H2d with the secondary height H1 based on data collected for at least 10 minutes, in particular 5 minutes, more particular 3 minutes, even more particular 15 minutes following the commencement of driving of the vehicle for effective detection of the load slippage of the vehicle 100. The time may change based on the level of difference of the primary and secondary heights.

In an embodiment, the secondary heights H2a, H2b, H2c, H2d can be different for each edge due to uneven surface and/or pressure of the vehicle tires when compared to the height H1. In many situations, when the vehicle 100 is in the driving state, the vehicle can tilt to either left or right side due to uneven road conditions. Therefore, the ECU is configured to initially detect the uneven surface due to which the secondary heights H2a, H2b, H2c, H2d may be different than the primary height H1. More particularly, the ECU is configured to compare secondary height H2a, H2b, H2c, H2d with primary height H1, based on data collected for at least 10 minutes, in particular 5 minutes, more particular 3 minutes, even more particular 15 minutes following the commencement of driving for effectively detecting the load slippage of the vehicle 100. The time may change based on the level of difference of the compared heights.

The ECU may analyze that the vehicle 100 is being tilted due to an uneven road conditions and not necessarily due to the load being unevenly distributed in a container. The uneven road conditions may cause the secondary heights H2a, H2b, H2c, H2d to differ frequently from the primary height H1. The ECU may register the time stamp when the vehicle 100 tilts due to uneven road during the driving mode and based on the irregular tilts of the vehicle and time stamp registered, ECU may determine that the vehicle is not being titled due to the uneven load but due to the uneven road conditions. In the condition of the vehicle getting tilted due to load slippage, the secondary heights H2a, H2b, H2c, H2d may not change frequently and are considered to remain unchanged for considerable time.

In an event of the vehicle 100 tilt due to the load slippage, the data captured due to the load slippage may be in the direction of the tilt position of the vehicle 100. When the load slippage and uneven road condition occurs simultaneously, the data captured may fluctuate more in the direction of the vehicle 100 tilt due to the load slippage. Further, if the vehicle 100 tilts due to the load slippage in a new direction, the data captured may tend to shift in the new direction of the load slippage.

In an embodiment, the load slippage in the vehicle 100 may be caused due to at least one of uneven load distribution, uneven road conditions and tipping of the load due to driving conditions.

According to an embodiment of the present disclosure, a dangerous situation may be determined by detecting a vehicle edge, in particular of the mounting frame 104, to the end on the left side and detecting a vehicle edge, in particular of the mounting frame 104, to the end on the right side. If both, in particular horizontal, edges are detected, a comparison can be made regarding the distance to the ground. By calculating an average over a certain period of time it may be determined whether the inclined position is permanent and based at least partly on a load slippage.

FIG. 3 shows a vehicle 100 in accordance with an embodiment of the present disclosure. The vehicle 100 comprises a load slippage detection system comprising at least one image data capturing device 102 that is configured to attach at the exterior of the vehicle 100. Particularly, there are two image data capturing devices 102a and 102b being disposed at each end of the exterior of the vehicle. The load detection system further comprises an ECU (not shown) comprising image data processor that processes image data captured by the at least one image data capturing device 102a, 102b. The image data or signal communication from the image data capturing device 102a and 102b to the ECU may comprise any suitable data or communication link, such as vehicle network bus. The ECU may be embedded at the interior of the vehicle 100.

The two image data capturing devices 102a, 102b capture the location of the reflector lights L1, L2 at each end of the vehicle 100 and the captured locations are transferred to the ECU. The ECU determines the height of the reflector lights from the ground as LH1 and LH2 based on the captured locations. The determined heights LH1 and LH2 are then transferred to the ECU wherein the ECU is configured to compare the heights LH1, LH2. The ECU further sends an alert notification to the vehicles driver once a load slippage is detected based on the height LH1 not being equal to the height LH2.

In an embodiment, the ECU is configured to compare the height LH2 of the second reflector light L2 with the height LH1 of the first reflector light L1 based on data collected for at least 10 minutes, in particular 5 minutes, more particular 3 minutes, even more particular 15 minutes following the commencement of driving of the vehicle for effective detection of the load slippage of the vehicle 100. The time may change based on the level of difference of the primary and secondary heights. In an embodiment, the reflector lights L1, L2 are on average at the same height. The reflector lights L1, L2 may be mounted on the rear end of the vehicle 100, which are important indicators during night, when it is dark.

In an embodiment, the at least one image data capturing device 102a is configured to be attached on the left side of the vehicle 100 to capture the location of reflector light L1 and at least one further image data capturing device 102b is configured to be attached on the right side of the vehicle 100 to capture the location of reflector light L2.

Since a vehicle's inclination may not be a matter of seconds, the vehicle 100 should receive data for a certain period of time while driving to rule out the possibility that the reason of the inclination is not a one-sided sloping road. If the vehicle 100 has a way to detect axle loads, e.g. on a CAN bus, this can be further information about positional displacement in combination with the optical system as described herein. This also holds true for tire pressure monitoring as well.

If an unusual tire pressure is one-sided and the system detects an optical imbalance, which runs parallel to the tire pressure, it may not be a matter of load slippage, but of a tire pressure problem.

If a system indicates that the axle load is different in the same way as the optical imbalance, then it may highly be likely that the load has slipped.

The CMS system can be switched on before, during, or after loading. By pre-storing and/or comparing values of the unloaded and/or partly loaded and/or fully loaded vehicle 100, it is possible to determine that there is no difference in the inclination when the vehicle is stationary after (un) loading/before (un) loading. This means that the system can be initialized. For example, when intermittently unloading a load from vehicle 100, which is loaded on one side, a new inclination angle may be measured with each unloading operation and displayed to the driver. If the driver does not want to change the imbalance by redistributing the load, this new angle may be stored and may form the basis for the subsequent real-time measurement to determine any load slippage.

The CMS system may also include one or more levelling sensor/tilt sensor to measure the inclination of the vehicle 100. Since the towing vehicle of the vehicle 100 is relatively independent of its trailer, it can be assumed that the inclination sensor is measuring the inclination of the road surface, the towing vehicle and the trailer. The tire pressure in the vehicle 100 must also be checked to rule out inclinations caused by differences in tire pressure.

If the system of the vehicle 100 detects an inclination of the road that differs significantly from the detected inclination of the trailer and/or the vehicle 100, it is determined that the trailer or vehicle 100 is in an impermissible inclined position. Measured over a longer period of time and compared with the tire pressure sensors and the initialization data of the last loading or unloading state of the vehicle 100, a load slippage can be detected.

Anti-slippery mats with pressure sensors may be used using a, e.g. radio, connection to the CMS system to localize load displacement very precisely. If the anti-slippery mat detects that the pressure has slipped and the CMS system indicates an externally recognizable inclination, the load slippage may be reported to the driver, e.g. as ‘very critical’. Otherwise, the load slippage may be displayed as a message.

Additional cameras in the interior of the vehicle 100, load image data capturing device, may be useful to generate further data to be processed by the ECU to detect load slippage. Load image data capturing devices may be used when monitoring tensioning belts, in particular for heavy loads, when otherwise no boxes would affect the field of view of the load image data capturing device. Having a dark interior sufficient infrared light may be provided and/or a TOF camera as load image data capturing device may be used. If the load slips, the tensioning belts would change as an object captured by the load image data capturing device and in addition change the static position if it tears, breaks at the holder, or on the floor fastening position.

An artificial intelligence may be used to detect load slippage, e.g. using pattern recognition, and is trained on tensioning belts and is therefore independent of cargo forms such as boxes.

The image data capturing device can be any appropriate camera or sensor. If desired, the image data capturing device can be a “smart camera,” encompassing an imaging sensor array along with related circuitry, image processing circuitry, electrical connectors, and similar components within a camera module.

Although the subject matter of the present disclosure has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims. i.e, the features disclosed in the foregoing description, the claims, and the drawings may be essential, both individually and in any combination, for accomplishing the present disclosure in its various embodiments. The embodiments shown herein are only examples of the present disclosure and must therefore not be understood as being restrictive. Alternative embodiments considered by the skilled person are equally covered by the scope of protection of the present disclosure.

The principle and mode of operation of this invention have been explained and illustrated in its preferred embodiment. However, it must be understood that this invention may be practiced otherwise than as specifically explained and illustrated without departing from its spirit or scope.

### REFERENCE SIGN LIST

100 vehicle
102, 102a, 102b image capturing device
104 mounting frame
H1 Primary height of the primary plane from the ground surface in unloaded condition
H2a, H2b, H2c, H2d Secondary heights of four edges of the secondary plane from the ground surface in loaded condition
L1 reflector light
L2 reflector light
LH1 height of the reflector light in loaded condition on one end of the vehicle
LH2 height of the reflector light in loaded condition on another end of the vehicle
P1 primary plane of mounting frame in unloaded condition
P2 secondary plane of mounting frame in loaded condition

What is claimed is:

1. A load slippage detection system for a vehicle, the system comprising:
at least one image data capturing device, and an electronic control unit (ECU), wherein the image data capturing device is adapted to capture image data at least for an exterior of the vehicle;
the ECU is configured to process the captured image data to generate at least one primary height from a ground and at least one secondary height from the ground; and
wherein the ECU is further configured to compare the primary height with the secondary height for detecting load slippage.

2. The load slippage detection system according to claim 1, wherein
the image data capturing device is configured to be attached at the exterior of the vehicle; and/or
the image data capturing device is configured to capture at least one location of at least one first reflector light and/or at least one second reflector light; and/or
the primary height is a height of a primary plane and/or of the first and/or second reflector light; and/or
the secondary height is a height of a secondary plane and/or of the first and/or second reflector light; and/or
the ECU is configured to process the captured image data to generate the primary height, at least one location of the first and/or second reflector light, and/or the primary plane, in one of a static position without a load or in a static position during or after loading or unloading the load onto the vehicle; and/or
the ECU is configured to process the captured image data to generate the secondary height, and determine at least one location of the first and/or second reflector light and/or the secondary plane, in one of a driving or a non-driving position during loading or unloading a load onto the vehicle and/or when loaded; and/or
the image data capturing device is disposed at the exterior of any one of A-pillars and/or a door of the vehicle.

3. The load slippage detection system according to claim 1, wherein
at least one of the image data capturing device is configured to be attached at a left side of the vehicle and configured to capture the position of the left side of a mounting frame of the vehicle; and/or
at least one of the image data capturing device is configured to be attached at a right side of the vehicle and configured to capture the position of the right side of the mounting frame of the vehicle.

4. The load slippage detection system according to claim 1, wherein the primary height is the primary height of a primary plane and is prestored in the ECU,
wherein the primary height of the primary plane is prestored in the ECU to enable the ECU to at least one of initialize the system, set at least one of the primary height or the location of the first and/or second reflector light of the primary plane or the primary height, or set the primary plane as at least one reference value, zero value, initializing value, and/or optimum value; and/or
wherein the primary height and/or the primary plane is generated and prestored in at least one of an unloaded state of the vehicle or an at least partly loaded state of the vehicle; and/or
wherein the prestored data of the primary height and/or primary plane is changed during or after a loading and/or unloading event.

5. The load slippage detection system according claim 4, wherein the primary plane is a rectangular plane or the primary plane is a rectangular plane having the same primary height of all four edges of the mounting frame from the ground; and/or
the secondary plane is a rectangular plane or the secondary plane is a rectangular plane having either the same or different secondary heights of the four edges from the ground.

6. The load slippage detection system according to claim 1, wherein the ECU is configured to detect a load slippage event in at least one of a static position without a load, a static position during or after loading or unloading the load onto the vehicle, a driving or non-driving position during loading or unloading the load onto the vehicle, or when the vehicle is loaded, when at least one of the following conditions is detected:
the secondary height is a plurality of secondary heights and at least one of the plurality of secondary heights does not match with the primary height;
at least two of the plurality of secondary heights do not have the same difference to one or more of the primary height configured as a height of a primary plane and/or a height of a first and/or second reflector light;
the alignment of the primary plane does not match the alignment of the secondary height configured as a secondary plane, or
the primary and secondary plane are not parallel to each other.

7. The load slippage detection system according to claim 1, wherein the ECU is configured to calculate a mean time value of the primary height and/or the secondary height configured as a plurality of secondary heights, and/or wherein the ECU is configured to distinguish a load slippage from an inclination of the vehicle due to an unevenness or inclination of the ground and/or street on which the vehicle is located.

8. The load slippage detection system according to claim 1, wherein the ECU is configured to assess at least one further parameter of the vehicle comprising:
at least one level value or inclination value of an at least one level sensor or inclination sensor,
at least one tire pressure,
at least one axle load, and/or
at least one pressure sensor, at least one pressure sensor located proximate to a load, and/or at least one pressure sensor comprised by at least one anti-slippery mat; and/or
the ECU is configured to distinguish:
a load slippage from an inclination of the vehicle, based on at least one of the level or inclination value,
a load slippage event from an inclination of the vehicle based on uneven tire pressure values,
a load slippage event from an inclination of the vehicle, in particular based on uneven tire pressure values and an inclination of the secondary plane; and/or
the ECU is configured to confirm a load slippage based on diverging axle loads and/or measured pressures being complementary to:
the difference in the primary height and secondary height,
the difference in the locations or heights of the first and/or second reflector light, and/or
the difference in the primary plane and the secondary plane.

9. The load slippage detection system of claim 8, wherein the ECU is connected to at least one network configured as a CAN-Bus of the vehicle to gather the at least one further parameter of the vehicle.

10. The load slippage detection system according to claim 1, wherein the ECU is configured to send an alert notification to a vehicle driver on an event of load slippage.

11. The load slippage detection system according to claim 10, wherein the ECU is configured to send the alert notification to the vehicle driver in the form of at least one of an audio announcement or a haptic feedback, and/or interact with at least one of a driving assistance system, suspension control, and/or hydraulic system.

12. The load slippage detection system according to claim 1, wherein the secondary height is a plurality of secondary heights and a comparison between any one of the plurality of secondary heights with the primary height is based on data collected by the ECU in time intervals of one of at least 3 minutes, 5 minutes, 10 minutes, or 15 minutes following commencement of driving of the vehicle.

13. The load slippage detection system according to claim 2, wherein the first reflector light and the second reflector light are located at left and right sides of a rear end of the vehicle.

14. The load slippage detection system according to claim 10, wherein the ECU is configured to send the alert notification to the vehicle driver when a load slippage event is detected by:
comparison of the primary height of a primary plane and the secondary height of a secondary plane, and/or
comparison of the primary height of a first reflector light and the secondary height of a second reflector light, and/or
comparison of the primary height of the primary plane, the secondary height of the secondary plane, the primary height of the first reflector light, and the secondary height of the second reflector light, and/or
comparison of the primary height of the primary plane and the primary height of the first reflector light and of the secondary height of the secondary plane and the secondary height of the second reflector light, and/or
comparison of the primary height of the primary plane and the secondary height of the second reflector light and of the secondary height of the secondary plane and the primary height of the first reflector light.

15. The load slippage detection system according to claim 1, wherein the load slippage event results from uneven load distribution, uneven road conditions, and/or tipping of the load due to driving conditions.

16. The load slippage detection system according to claim 1, wherein the system further comprises at least one load image data capturing device gathering optical information of at least a part of a load, at least one tensioning belt, and/or at least one securing element used to secure the load to the vehicle, and/or the load illuminated by at least one illumination device using visible light and/or infrared light, wherein the ECU is configured to analyze the data provided by the load image data capturing device to recognize a movement of the load and/or the securing element and/or a malfunction of the securing element.

17. The load slippage detection system according to claim 1, wherein the ECU uses at least one artificial intelligence algorithm to detect one of a load slippage event or tearing off of a tensioning belt.

18. A vehicle with the load slippage detection system of claim 1.
